(19) United States
(12) Patent Application Publication
(10) Pub. No.: US 2012/0041887 A1
(43) Pub. Date: Feb. 16, 2012

(54) METHOD AND ARRANGEMENT FOR RETRIEVING INFORMATION RELATED TO A PRODUCT

(75) Inventors: Eero Hurme, Espoo (FI); Jouko Hyvakka, Helsinki (FI); Caj Sodergard, Espoo (FI)

(73) Assignee: TEKNOLOGIAN TUTKIMUSKESKUS VTT, VTT (FI)

(21) Appl. No.: 13/262,680

(22) PCT Filed: Mar. 29, 2010
(86) PCT No.: PCT/FI2010/050244

§ 371 Date: Nov. 1, 2011

(30) Foreign Application Priority Data
Apr. 3, 2009 (FI) 20095366

(51) Int. Cl. G06Q 99/00; B23P 17/04

(52) U.S. Cl. 705/318; 29/592

(57) ABSTRACT

An arrangement for enabling an acting party, e.g. a natural person or an automatic inspection line, to retrieve information from a product (150), e.g. for genuineness verification, includes an optical device (102) for optically receiving auxiliary information from the product, a processing system (103) for retrieving instruction data from a database (104) on the basis of the auxiliary information, and a data interface (105) for delivering the instruction data to the acting party for enabling the acting party to retrieve the information. In the genuineness verification application, the verification is provided with two separate components. A first component resides in the auxiliary information on the surface of the product and a second component resides in the instruction data. The division of the genuineness verification into the two components makes it more difficult for a counterfeit manufacturer to analyze the counterfeit protection and to follow changes in the counterfeit protection.

### FIELD OF THE INVENTION

The invention relates generally to a method and arrangement for retrieving information related to a product. The information may be arranged to indicate, for example but not necessarily, whether the product is genuine or counterfeit. Furthermore, the invention relates to a user terminal device, a server device, and a computer program for retrieving information related to a product. Furthermore, the invention relates to a product equipped with encoded information that can represent, for example but not necessarily, a genuineness certificate, and to a method for manufacturing the product.

### BACKGROUND

Product counterfeiting is a significant world-wide problem and, within distribution systems of products, there is therefore a need to assure genuineness of products. For example, in the specific field of drug products it is extremely important to be able to identify and differentiate genuine and counterfeit products, and to assure the distribution of the genuine products to retailers and to other relevant parties from distribution or manufacturing sites of the said products. Due to the above-presented reasons, there is a need to provide certain products with information that can be used, for example, for verifying whether a product is genuine, for providing a user with product data, and for other possible purposes.

Publication US2008/0116276 discloses a counterfeit-proof certificate that can be attached or printed to a surface of a product or a package. The counterfeit-proof certificate comprises a photo chromogenic layer of a lenticular material and has an optically concealed, invisible universal product code. The color bars of the product code are optically split and compressed in high resolution image elements and arranged at the pre-calculated optical blind angles in relation to the optical center of the lenticule and a pre-determined viewing distance of the label. Due to the optical effect of the lenticule, the complete product code is not visible when viewing at a normal viewing distance. The camera of a mobile phone can be used for photo-graphing the counterfeit-proof certificate at a close-up distance so that the lens of the camera regroups the split image elements of all the color bars to reconstruct the product code that will be displayed on a display screen of the mobile phone. The user can match the product code displayed on the screen with a reference code by visual identification, or a color photo of the product code can be sent using the mobile phone to a control center for computer matching and verification and the user will be advised of the result afterwards. The above described counterfeit protection arrangement requires usage of the lenticular material the cost efficiency of which may in some cases be questionable and, on the other hand, a counterfeit manufacturer could analyze the certificate and try to make copies of it.

### SUMMARY

In accordance with a first aspect of the invention there is provided a new arrangement for enabling an acting party to retrieve information related to a product. The arrangement according to the invention comprises:
an optical device arranged to optically receive auxiliary information from a surface of the product,
a processing system arranged to retrieve instruction data from a database on the basis of the optically received auxiliary information, the instruction data describing actions to be performed in order to retrieve the information related to the product from the product itself, and
a data interface arranged to deliver the instruction data to the acting party so as to enable the acting party to retrieve the information related to the product from the product.

The acting party can be for example a customer buying the product or a customs officer who is inspecting the product but who is not actually going to use the product. The acting party can also be, for example, equipment of an automatic inspection or assembly line, which equipment is arranged to perform the actions defined by the instruction data. The product can be a package of an actual product or the product can be the actual product itself.

In an arrangement according to an advantageous embodiment of the invention, the instruction data comprises instructions to the acting party so as to enable the acting party to verify whether the product is genuine or counterfeit. In this case the arrangement is suitable for verifying whether a product is genuine or counterfeit. In the arrangement according to this embodiment of the invention, the information that is used for verifying the genuineness of the product is provided as two separate components. A first component of the said information resides in optically receivable auxiliary information on the surface of the product and a second component of the said information resides in the instruction data. The division of the genuineness verification information into the two components as described above makes it more difficult for a counterfeit manufacturer to analyze the counterfeit protection and to follow changes in the counterfeit protection.

In accordance with a second aspect of the invention there is provided a new user terminal device for enabling a user to retrieve information related to a product. The user terminal device according to the invention comprises:
an optical device arranged to optically receive auxiliary information from a surface of the product,
a processing system arranged to retrieve instruction data from a database on the basis of the optically received auxiliary information, the instruction data describing actions to be performed by the user in order to retrieve the information related to the product from the product itself, and
a user interface arranged to present the instruction data to the user.

The user can be for example a customer buying the product or a customs officer who is inspecting the product but who is not actually going to use the product. Hence, the word “user” means in this document the one who retrieves the information related to the product for example in order to verify whether the product is genuine or counterfeit.

In accordance with a third aspect of the invention there is provided a new server device. The server device according to the invention comprises:
a data transfer interface for receiving data from a user terminal device and for transmitting data to the user terminal device, and
a processing system arranged to (i-ii):
(i) retrieve instruction data from a database on the basis of information received from the user terminal device, the instruction data describing actions to be performed by a user of the user terminal device in order to retrieve information related to a product from the product itself, and
(ii) control the data transfer interface to transmit the instruction data to the user terminal device.

In accordance with a fourth aspect of the invention there is provided a new computer program for enabling an acting party to retrieve information related to a product. The computer program comprises computer executable instructions for controlling a programmable processor to:
retrieve instruction data from a database on the basis of auxiliary information received optically from a surface of the product, the instruction data describing actions to be performed in order to retrieve the information related to the product from the product itself, and
control a data interface to deliver the instruction data to the acting party so as to enable the acting party to retrieve the information related to the product from the product.

A computer program product according to the invention comprises a computer readable medium, e.g. a compact disc (CD), encoded with a computer program according to the invention.

In accordance with a fifth aspect of the invention there is provided a new product equipped with information encoded to the product and relating to the product. The said information may represent, for example but not necessarily, a genuineness certificate. The product comprises image elements on the surface of the product, wherein the image elements are responsive to physical actions directed to the image elements and the information related to the product is arranged to be indicated so that the image elements are arranged to respond to the physical actions in a pre-determined manner when the physical actions are according to predetermined instructions.

The physical action can be, for example, warming or cooling certain areas on the surface of the product, pressing the areas on the surface of the product, exposing the areas on the surface of the product to moisture, illuminating the areas on the surface of the product with light, infrared, or ultraviolet radiation, or exposing the areas on the surface of the product to chemical substance.

In a product according to an advantageous embodiment of the invention, at least one of the image elements is a genuineness certificate, and the genuineness of the product is arranged to be indicated so that the genuineness certificate is arranged to respond to the physical actions in the pre-determined manner as a response to a situation in which the physical actions are according to pre-determined instructions. Hence, the information that can be used for verifying the genuineness of the product is provided as two separate components. A first component of the said information is residing in the image elements and a second component of the said information is residing in the way the physical actions are to be performed.

In accordance with a sixth aspect of the invention there is provided a new method for manufacturing a product according to the invention. The method comprises:
making, by a first member of a production chain of the product, a first part of the image elements, and
making, by a second member of the production chain of the product, a second part of the image elements.

The first member of the production chain of the product may be for example a material manufacturer and the second member of the production chain of the product can be for example a manufacturer who makes the final product of the material produced by the first member. Hence, both the first member and the second member can retrieve information, e.g. verify the genuineness of the material and/or the product, together or separately.

A number of exemplifying embodiments of the invention are described in accompanied dependent claims.

Various exemplifying embodiments of the invention both as to constructions and to methods of operation, together with additional objects and advantages thereof, will be best understood from the following description of specific exemplifying embodiments when read in connection with the accompanying drawings.

The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The exemplifying embodiments of the invention and their advantages are explained in greater detail below with reference to the accompanying drawings, in which:

FIG. 1 shows a schematic illustration of an arrangement according to an embodiment of the invention for enabling an acting party to retrieve information related to a product from the product itself,

FIGS. 2a-2f show exemplifying ways of verifying the genuineness of a product with the aid of the arrangement shown in FIG. 1,

FIG. 3 shows a schematic illustration of a system comprising an arrangement according to an embodiment of the invention for enabling a user to retrieve information related to a product from the product itself,

FIG. 4 shows a schematic illustration of a user terminal device according to an embodiment of the invention for enabling a user to retrieve information related to a product from the product itself,

FIG. 5 shows a schematic illustration of a server device according to an embodiment of the invention for enabling a user of a separate user terminal device to retrieve information related to a product from the product itself, and

FIG. 6 shows a flow chart of a method according to an embodiment of the invention for enabling an acting party to retrieve information related to a product from the product itself.

### DESCRIPTION OF THE EXEMPLIFYING EMBODIMENTS

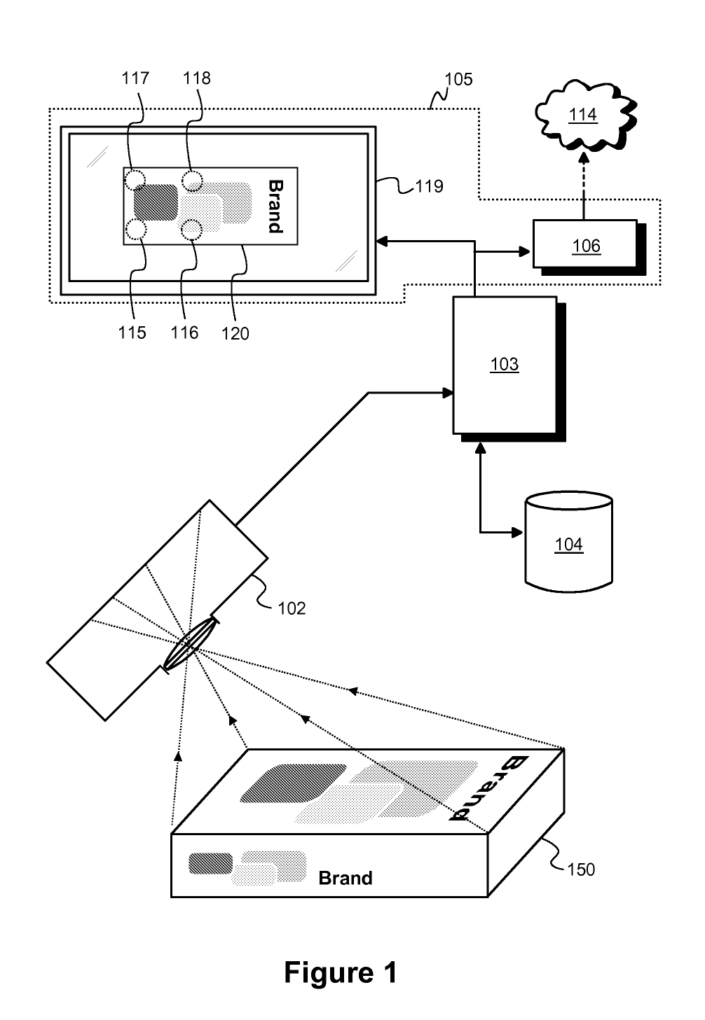

FIG. 1 shows a schematic illustration of an arrangement according to an embodiment of the invention for enabling an acting party, e.g. a natural person or an automatic inspection or assembly line, to retrieve information related to a product 150 from the product itself. The information can be retrieved, for example but not necessarily, in order to verify whether the product is genuine or counterfeit. In addition to or instead of the genuineness indication, the information can identify, for example, the individual product currently being handled, a production batch to which the product belongs, an age group or a date of manufacture of the product, and/or a site of manufacture of the product. In FIG. 1, the product is a package of an actual, final-use product. It is naturally also possible that the product to be inspected is the actual, final-use product itself. The arrangement comprises an optical device 102 that is arranged to optically receive auxiliary information from a surface of the product 150. The arrangement comprises a processing system 103 that comprises one or more processors and is arranged to retrieve instruction data from a database 104 on the basis of the optically received auxiliary information. The instruction data describes the actions to be taken by the acting party in order to retrieve the information related to the product 150 from the product itself.

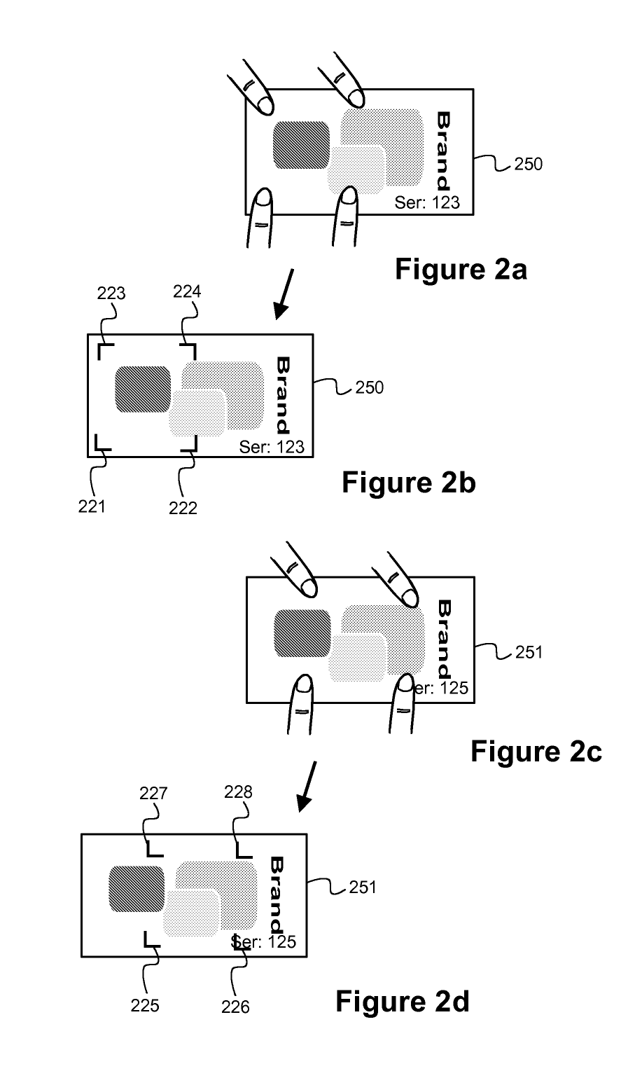

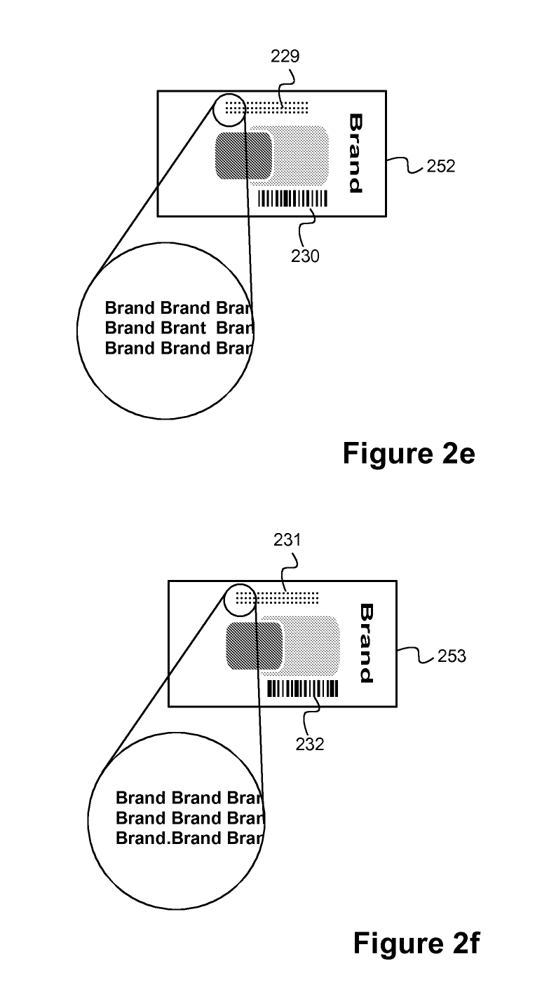

In an arrangement according to an embodiment of the invention, the instruction data comprises instructions to the acting party so as to enable the acting party to verify whether the product is genuine or counterfeit. In this case, the arrangement is suitable for verifying whether a product is genuine or counterfeit. Exemplifying ways of verifying the genuineness of a product on the basis of the instruction data are given later in this document and with the aid of FIGS. 2a-2f.

In the exemplifying arrangement shown in FIG. 1, the optical device 102 is a camera that is preferably, but not necessarily, a digital camera and the optically received information is a photograph of the product 150. The processing system 103 is arranged to apply image recognition to the photograph and to retrieve the instruction data from the database 104 on the basis of the result of the image recognition. The result of the image recognition can identify, for example, one of more of the following: the individual product 150 currently being handled, a production batch to which the product belongs, an age group or a date of manufacture of the product, and/or a site of manufacture of the product. The processing system 103 can be arranged to select from among all the instruction data stored in the database 104 the particular instruction data that is, for example, specific to the individualised product and/or specific to the identified production batch and/or specific to the identified age group or date of manufacture and/or specific to the identified site of manufacture. The image recognition can be performed for example using one or more of the following known image recognition algorithms: Color Coherent Vector (CCV), Gradient Location and Orientation Histogram (GLOH), Local Binary Pattern (LBP), Local Energy based Shape Histogram (LESH), Scale-invariant feature transform (SIFT), and/or Speeded Up Robust Features (SURF).

The arrangement comprises a data interface 105 that is arranged to deliver the instruction data to the acting party so as to enable the acting party to retrieve the information related to the product from the product. The data interface may comprise e.g. a display screen 119 for presenting the instruction data to a user who is retrieving the information related to the product. The data interface may as well comprise a data port 106 for delivering the instruction data to equipment of an automatic inspection or assembly line, which equipment is arranged to perform the actions defined by the instruction data. Figure is shows an exemplifying situation in which the display screen 119 shows an image 120 of the product 150. The display screen 119 shows also dashed circles 115, 116, 117, and 118, which indicate areas on the surface of the product 150. The information, e.g. an indicator of genuineness, can be retrieved from the product by directing a pre-determined physical action to the said areas on the surface of product 150. In this case, the image 120 of the product 150 and the dashed circles 115-118 represent at least a part of the instruction data. The display screen 119 may also be arranged to display at least part of the instruction data in the form of text.

The areas indicated by the instruction data and also some other areas on the surface of the product can be coated for example with ink or label that is responsive to a temperature change so that an image emerges, vanishes or otherwise changes as a response to warming or cooling the coated area. In this case, the pre-determined physical action can be warming or cooling the relevant areas on the surface of the product. As another example, the indicated areas and also some other areas on the surface of the product can be coated for example with ink or label that is responsive to pressure so that an image emerges, vanishes or otherwise changes as a response to pressing the coated area. In this case, the pre-determined physical action can be pressing the relevant areas on the surface of the product. As a third example, the indicated areas and also some other areas on the surface of the product can be coated for example with ink or label that is responsive to moisture so that an image emerges, vanishes or otherwise changes as a response to exposing the coated area to moisture. In this case, the pre-determined physical action can be exposing the relevant areas on the surface of the product to moisture. As a fourth example, the indicated areas and also some other areas on the surface of the product can be coated for example with ink or label that is responsive to light, infrared or ultraviolet radiation exceeding a pre-determined intensity so that an image emerges, vanishes or otherwise changes as a response to exposing the coated area to the light, infrared or ultraviolet radiation. In this case, the pre-determined physical action can be illuminating the relevant areas on the surface of the product with to the light, infrared or ultraviolet radiation. As a fifth example, the indicated areas and also some other areas on the surface of the product can be coated for example with ink or label that is responsive to a certain chemical substance so that an image emerges, vanishes or otherwise changes as a response to exposing the coated area to the said chemical substance. In this case, the pre-determined physical action can be exposing the relevant areas on the surface of the product to the said chemical substance. It is also possible to coat different areas on the surface of the product with differently reactive ink or labels e.g. according to two or more of the above-mentioned examples.

It is also possible to coat different areas on the surface of the product with time-dependent color-changing ink or labels.

An arrangement according to an embodiment of the invention comprises one or more memory devices arranged to store the database 104. An arrangement according to another embodiment of the invention comprises a data transfer interface arranged to allow the processing system 103 to communicate with an external device including the database 104.

FIGS. 2a-2d show exemplifying ways of verifying the genuineness of a product on the basis of the instruction data. FIG. 2a shows a situation in which the user warms and/or presses certain areas on a surface of a product 250. It is assumed that the instruction data indicates the relevant areas to be warmed and/or pressed. The areas may be indicated for example in the display screen 119 as shown in FIG. 1. FIG. 2b shows the situation after the user has warmed and/or pressed the said areas. In this example L-shaped graphs 221, 222, 223, and 224 emerge on the areas that have been warmed and/or pressed. The instruction data may, in addition to indicating the areas to be warmed and/or pressed, comprise information that indicates what should be the response of warming and/or pressing the indicated areas. The instruction data may, for example, contain information indicating that the L-shaped graphs that emerge should be oriented with respect to each other like corners of a rectangle as it is shown in FIG. 2b. Hence, the genuineness of the product 250 is verified if the product responds to the physical actions defined in the instruction data in a manner that is also defined in the instruction data. It is also possible to arrange, for example, a serial number and/or other product related information to become visible as a response to a situation in which the user presses and/or warms a pre-determined area on the surface of the product.

FIG. 2c shows a situation in which the user warms and/or presses certain areas on a surface of a product 251. The product 251 may be otherwise similar to the product 250 but the product 251 may represent e.g. a different production batch than the product 250. The processing system 103 shown in FIG. 1 may be arranged to identify the production batch on the basis of the optically received auxiliary information. For example in the case illustrated in FIGS. 2a-2d, the processing system may identify the production batch on the basis of codes “Ser: 123” and “Ser: 125” printed on the surfaces of the products 250 and 251, respectively. FIG. 2d shows the situation after the user has warmed and/or pressed the said areas. In this example L-shaped graphs 225, 226, 227, and 228 emerge on the areas that have been warmed and/or pressed in such a manner that all the said L-shaped graphs are mutually in the same position as it is shown in FIG. 2d. Hence, for positive verification of the genuineness of the product 250 or 251, the physical action defined in the instruction data, the response to the physical action i.e. the emergence of the L-shaped graphs, and the production batch have to correspond to each other. The above-mentioned identification of the production batch can be replaced or supplemented for example with identification of an individual product or with identification of product age or a date of manufacture or with identification of a site of manufacture. It is also possible, that for positive verification of the genuineness of a product, only the physical action defined in the instruction data and the response to the physical action have to correspond to each other, i.e. the identification of an individual product, the identification of a production batch or the identification of some other thing is not necessary in all arrangements according to different embodiments of the invention.

In an arrangement according to an embodiment of the invention, the optical device 102 shown in FIG. 1 is arranged to read a graphical code pattern from the surface of the product. The processing system 103 is arranged to retrieve the instruction data from the database 104 on the basis of the auxiliary information represented by the graphical code pattern. The optical device may be arranged to read and the processing system may be arranged to decode for example one or more of the following graphical code patterns: a bar code, a matrix code, a string of alpha-numeric characters, figure elements, and/or other visual features.

FIGS. 2e and 2f show exemplifying ways of verifying the genuineness of a product on the basis of the instruction data. FIG. 2e shows a product 252 having a bar code 230 printed or otherwise attached to its surface. The instruction data is retrieved from the database 104 shown in FIG. 1 on the basis of information read from the bar code 230. The instruction data is arranged to indicate one or more details on the surface of the product. This or these one or more details is/are to be checked in order to verify whether the product 252 is genuine or counterfeit. In the exemplifying case illustrated in FIG. 2e, the above-mentioned one or more details reside in the text 229 printed or otherwise attached to the surface of the product. In this case, the instruction data indicates that the product is genuine if the second word from the left on the second row from the top is the word “brant” instead of the word “brand”. FIG. 2f shows a product 253 that is otherwise similar to the product 252 but the product 253 has a different bar code 232 than that of the product 252. In this case, the instruction data corresponding with the bar code 232 indicates that the product is genuine if there is a dot “.” between the first and second words from the left on the third row from the top. The bar codes 230 and 232 may indicate for example an individual product, a production batch, a date of manufacture, a product type, a site of manufacture, and/or any other suitable information that can be used for the product verification.

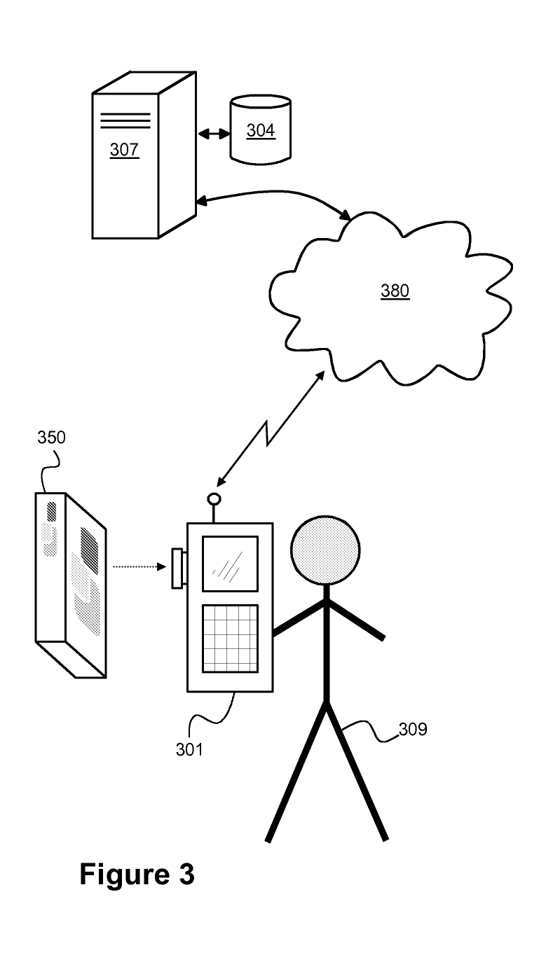

FIG. 3 shows a schematic illustration of a system comprising an arrangement according to an embodiment of the invention for enabling a user to retrieve information related to a product from the product itself. The information can be retrieved, for example but not necessarily, in order to verify whether the product is genuine or counterfeit. The system comprises a user terminal device 301 and a server device 307 that are interconnected via a communication network 380. The functional elements of the arrangement shown in FIG. 1 are located in the system in the following manner. The user terminal device 301 comprises:
the optical device arranged to optically receive auxiliary information from a surface of a product 350, and
the data interface arranged to present the instruction data to a user 309 of the user terminal device so as to enable the user to retrieve the information related to the product 350 from the product.

Furthermore, the user terminal device comprises a data transfer interface for transmitting data based on the optically received auxiliary information to the server device 307 and for receiving the instruction data from the server device.

The server device 307 comprises the processing system arranged to retrieve the instruction data from the database 304 on the basis of the auxiliary information received from the user terminal device 301. Furthermore, the server device comprises a data transfer interface for transmitting the instruction data to the user terminal device 301 and for receiving the data based on the optically received auxiliary information from the user terminal device.

In a system according to another embodiment of the invention, the user terminal device 301 comprises:
the optical device,
the data interface, and
the processing system.

The user terminal device may further comprise a data transfer interface for downloading the whole database 304 or relevant items of the database. The database can be downloaded wholly or partly for example via the communication network 380 or from a memory device such as a USB-memory device (Universal Serial Bus). In the latter case, the user terminal device is able to operate independently without a connection to the communication network.

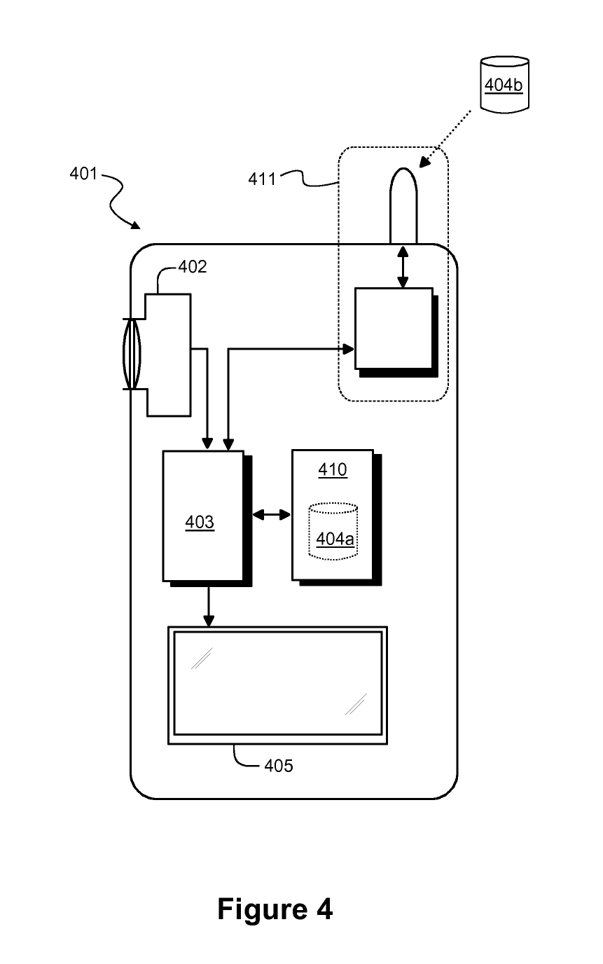

FIG. 4 shows a schematic illustration of a user terminal device 401 according to an embodiment of the invention for enabling a user to retrieve information related to a product from the product itself. The user terminal device comprises an optical device 402 arranged to optically receive auxiliary information from a surface of the product. The user terminal device comprises a processing system 403 arranged to retrieve instruction data from a database 404a and/or 404b on the basis of the optically received auxiliary information, wherein the instruction data describes actions to be performed by a user in order to retrieve the information related to the product from the product. The user terminal device comprises a user interface 405 arranged to present the instruction data to the user.

In a user terminal device according to an embodiment of the invention, the instruction data comprises instructions to the user so as to enable the user to verify whether the product is genuine or counterfeit.

A user terminal device according to an embodiment of the invention comprises a data transfer interface 411 for receiving data from a separate device including the database 404b.

A user terminal device according to an embodiment of the invention comprises a memory device 410 for storing the database 404a.

A user terminal device according to an embodiment of the invention comprises a mobile phone, a palmtop computer, a personal digital assistant, or a combination of two or more of them.

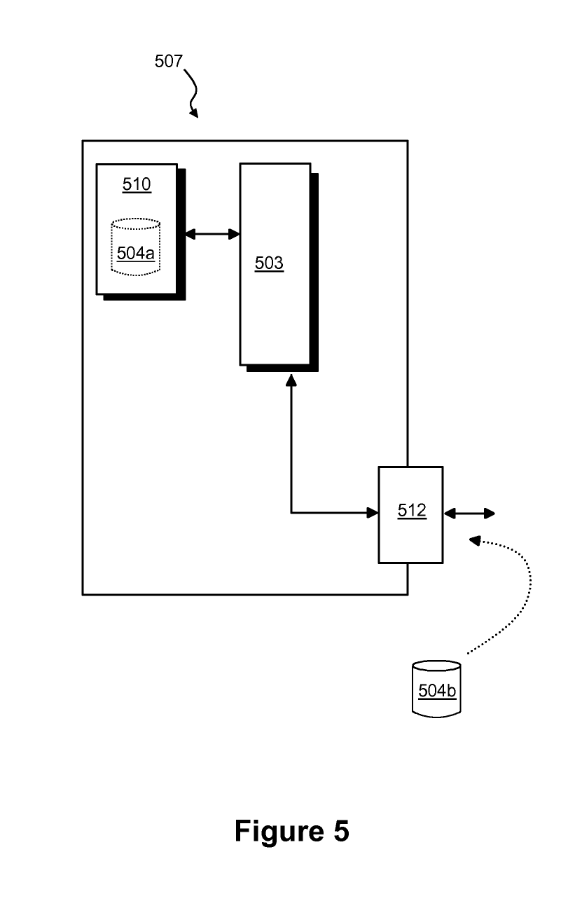

FIG. 5 shows a schematic illustration of a server device 507 according to an embodiment of the invention for enabling a user of a separate user terminal device to retrieve information related to a product from the product itself. The server device comprises a data transfer interface 512 for receiving data from the user terminal device and for transmitting data to the user terminal device, The server device comprises a processing system 503 arranged to:
retrieve instruction data from a database 504a and/or 504b on the basis of auxiliary information received from the user terminal device, wherein the instruction data describes actions to be performed by the user of the user terminal device in order to retrieve information related to a product from the product itself, and
control the data transfer interface 512 to transmit the instruction data to the user terminal device.

In a server device according to an embodiment of the invention, the instruction data comprises instructions to the user of the user terminal device so as to enable the user of the user terminal device to verify whether the product is genuine or counterfeit.

In a server device according to an embodiment of the invention, the processing system 503 is arranged to retrieve the instruction data via the data transfer interface from a separate device including the database 504b.

A server device according to an embodiment of the invention comprises a memory device 501 for storing the database 504a.

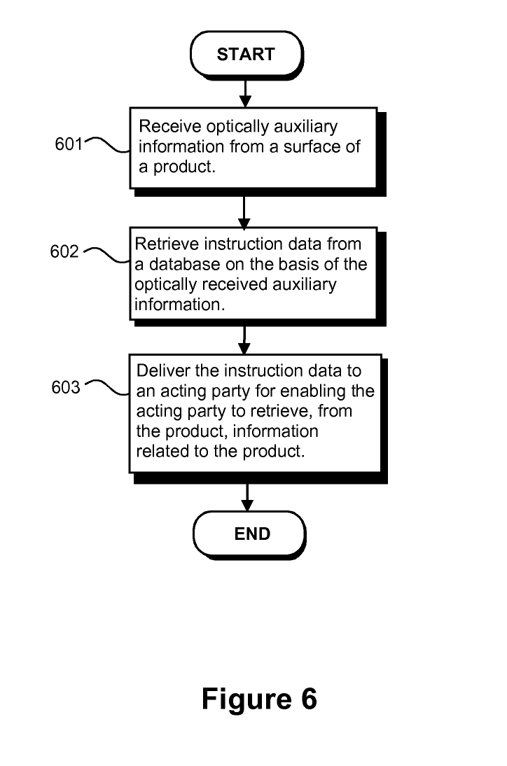

FIG. 6 shows a flow chart of a method according to an embodiment of the invention for enabling an acting party, e.g. a natural person or an automatic inspection or assembly line, to retrieve information related to a product from the product itself. The method comprises:
in the phase 601, receiving optically auxiliary information from a surface of the product to be verified,
in the phase 602, retrieving instruction data from a database on the basis of the optically auxiliary received information, the instruction data describing actions to be performed in order to retrieve the information related to the product from the product itself, and
in the phase 603, delivering the instruction data to the acting party so as to enable the acting party to retrieve the information related to the product from the product.

In a method according to an embodiment of the invention, the instruction data delivered in the phase 603 comprises instructions to the acting party so as to enable the acting party to verify whether the product is genuine or counterfeit.

In a method according to an embodiment of the invention, the phase 601 comprises producing a photograph of the product with a camera, and the phase 602 comprises applying image recognition to the photograph of the product and retrieving the instruction data from the database on the basis of the result of the image recognition.

In a method according to an embodiment of the invention, at least one of the following known image recognition algorithms is used for the image recognition:

Color Coherent Vector (CCV), Gradient Location and Orientation Histogram (GLOH), Local Binary Pattern (LBP), Local Energy based Shape Histogram (LESH), Scale-invariant feature transform (SIFT), and/or Speeded Up Robust Features (SURF).

In a method according to an embodiment of the invention, the phase 601 comprises optically reading a graphical code pattern from the surface of the product, and the phase 602 comprises retrieving the instruction data from the database on the basis of the auxiliary information represented by the graphical code pattern. The graphical code pattern can comprise for example a bar code, a matrix code, a string of alpha-numeric characters, figure elements, and/or other visual features.

In a method according to an embodiment of the invention, the phase 602 comprises individualising, on the basis of the optically received auxiliary information, the particular product being verified and selecting the instruction data specific to the particular product from among all instruction data stored in the database.

In a method according to an embodiment of the invention, the phase 602 comprises identifying, on the basis of the optically received auxiliary information, a production batch to which the product being verified belongs and selecting the instruction data specific to the identified production batch from among all instruction data stored in the database.

In a method according to an embodiment of the invention, the phase 602 comprises identifying, on the basis of the optically received auxiliary information, an age group of the product being verified and selecting the instruction data specific to the identified age group from among all instruction data stored in the database.

In a method according to an embodiment of the invention, the phase 603 comprises presenting at least a part of the instruction data in a form of an image on a display screen.

In a method according to an embodiment of the invention, the phase 603 comprises presenting at least a part of the instruction data in a form of a text on a display screen.

In a method according to an embodiment of the invention, the instruction data indicates areas on the surface of the product, which areas are to be exposed to a pre-determined physical action in order to retrieve the information related to the product from the product.

In a method according to an embodiment of the invention, the instruction data indicates areas on the surface of the product, which areas are to be exposed to a pre-determined physical action in order to verify whether the product is genuine or counterfeit.

In a method according to an embodiment of the invention, the above-mentioned pre-determined physical action comprises one of the following: warming or cooling the areas on the surface of the product, pressing the areas on the surface of the product, exposing the areas on the surface of the product to moisture, illuminating the areas on the surface of the product with light, infrared, or ultraviolet radiation, exposing the areas on the surface of the product to a chemical substance.

It is also possible to coat different areas on the surface of the product with time-dependent color-changing ink or labels.

In a method according to an embodiment of the invention, the instruction data indicates one or more details on the surface of the product, which one or more details are to be checked in order to retrieve the information related to the product from the product.

In a method according to an embodiment of the invention, the instruction data indicates one or more details on the surface of the product, which one or more details are to be checked in order to verify whether the product is genuine or counterfeit.

A computer program according to an embodiment of the invention comprises computer executable instructions for controlling a programmable processor to:
retrieve instruction data from a database on the basis of auxiliary information received optically from a surface of a product, the instruction data describing actions to be performed in order to retrieve information related to the product from the product itself, and
control a data interface to deliver the instruction data to an acting party, e.g. a natural person or equipment of an inspection or assembly line, so as to enable the acting party to retrieve the information related to the product from the product.

In a computer program according to an embodiment of the invention, the instruction data comprises instructions to the acting party so as to enable the acting party to verify whether the product is genuine or counterfeit.

The computer executable instructions can be e.g. subroutines and/or functions.

A computer program product according to an embodiment of the invention comprises a computer readable medium encoded with a computer program according to an embodiment of the invention. The computer readable medium can be e.g. a CD-ROM (Compact Disc Read Only Memory) or a RAM-device (Random Access Memory).

A computer program product according to an embodiment of the invention is a signal that is encoded with a computer program according to an embodiment of the invention and is receivable from a communication network.

A product equipped with information relating to the product and encoded to the product according to an embodiment of the invention comprises image elements on the surface of the product. The image elements are responsive to physical actions directed to the image elements and the information related to the product is arranged to be indicated so that the image elements are arranged to respond to the physical actions in a pre-determined manner when the physical actions are according to pre-determined instructions. The image elements can be responsive to, for example, temperature change, pressure, moisture, light, infrared, or ultraviolet radiation, ageing, chemical substances such as e.g. certain gases e.g. oxygen, etc.

The physical action can be, for example, warming or cooling the image elements, pressing the image elements, exposing the image elements to moisture, illuminating the image elements with light, infrared, or ultraviolet radiation, or exposing the image elements to chemical substance.

A product equipped with a genuineness certificate according to an embodiment of the invention comprises image elements, e.g. such as the L-shaped 221-228 graphs shown in FIGS. 2a-2d, on the surface of the product. The image elements are responsive to physical actions directed to the image elements and the genuineness of the product is arranged to be indicated so that the image elements are arranged to respond to the physical actions in a pre-determined manner as a response to a situation in which the physical actions are according to pre-determined instructions.

Pressure sensitive image elements can be implemented for example with two closely spaced layers which are separated by an array of tiny elastic blobs. The top layer is preferably transparent or translucent. As pressure on surface increases the blobs spread out, thus the color of the surface changes. The color of the elastic blobs is preferably opposite the color of the bottom layer to maximize the color changing effect.

Temperature and/or infrared radiation sensitive image elements can be implemented for example with thermochromic inks or dyes that are temperature sensitive compounds which permanently or temporarily change color with exposure to a temperature change.

Light sensitive image elements can be implemented for example with phosphorescent inks with special pigments that emit light, glowing in the dark, if they are charged by light. A photograph of the product or other optically received auxiliary information is preferably taken in dark environment, because the image elements glow in the dark after being charged by light.

Ultraviolet radiation sensitive image elements can be implemented for example with fluorescent pigments made of inorganic nanoparticles based on different crystals doped with rare earth ions. These nanoparticles are known from applications in automobile industry, material sciences, medicine and pharmacy.

In a product according to an embodiment of the invention one or more image elements that are responsive to physical action is/are image elements covered with removable labels and/or layers of colorant that can be removed e.g. by sweeping or releasing a layer when the information is to be retrieved from the product or when the product is made available to purchasers.

A method according to an embodiment of the invention for manufacturing a product according to an embodiment of the invention comprises:
making, by a first member of a production chain of the product, a first part of image elements that are responsive to physical actions directed to the image elements, and
making, by a second member of the production chain of the product, a second part of the image elements that are responsive to physical actions directed to the image elements.

The first member of the production chain of the product may be for example a material manufacturer and the second member of the production chain of the product can be for example a manufacturer who makes e.g. a package of the material produced by the first member. Hence both the first member and the second member can retrieve information, e.g. verify the genuineness of the product, together or separately.

The specific examples provided in the description given above should not be construed as limiting. Therefore, the invention is not limited merely to the embodiments described above, many variants being possible.

1.-49. (canceled)

50. An arrangement for enabling an acting party to retrieve information related to a product, the arrangement comprising:
an optical device arranged to optically receive auxiliary information from a surface of the product,
a processing system arranged to retrieve instruction data from a database on the basis of the optically received auxiliary information, the instruction data describing actions to be performed in order to retrieve the information related to the product from the product itself, and
a data interface arranged to deliver the instruction data to the acting party so as to enable the acting party to retrieve the information related to the product from the product, wherein that the processing system is arranged to carry out, on the basis of the optically received auxiliary information, at least one of the following (i-iii): (i) individualization of the product, (ii) identification of a production batch to which the product belongs, (iii) identification of an age group of the product, and the processing system is arranged to select the instruction data from among all instruction data stored in the database on the basis of at least one of the following: the individualization of the product, the production batch, the age group, and wherein the instruction data is arranged to indicate, from the surface of the product, areas which are to be exposed to one of the following actions in order to retrieve the information related the product: warming the areas on the surface of the product, pressing the areas on the surface of the product, exposing the areas on the surface of the product to moisture.

51. An arrangement according to claim 50, wherein the instruction data comprises instructions to the acting party so as to enable the acting party to verify whether the product is genuine or counterfeit.

52. An arrangement according to claim 50, wherein the optical device comprises a camera for producing a photograph of the product and the processing system is arranged to apply image recognition to the photograph of the product and to retrieve the instruction data from the database on the basis of the result of the image recognition.

53. An arrangement according to claim 52, wherein the processing system is arranged to use at least one of the following image recognition algorithms for the image recognition: Color Coherent Vector (CCV), Gradient Location and Orientation Histogram (GLOH), Local Binary Pattern (LBP), Local Energy based Shape Histogram (LESH), Scale-invariant feature transform (SIFT), Speeded Up Robust Features (SURF).

54. An arrangement according to claim 50, wherein the optical device is arranged to read a graphical code pattern from the surface of the product and the processing system is arranged to retrieve the instruction data from the database on the basis of the auxiliary information represented by the graphical code pattern.

55. An arrangement according to claim 54, wherein processing system is arranged to decode at least one of the following graphical code patterns: a bar code, a matrix code, a string of alpha-numeric characters, figure elements, visual features.

56. An arrangement according to claim 50, wherein the data interface comprises a display screen arranged to present at least a part of the instruction data in a form of an image.

57. An arrangement according to claim 50, wherein the data interface comprises a display screen arranged to present at least a part of the instruction data in a form of a text.

58.-62. (canceled)

63. An arrangement according to claim 50, wherein the arrangement is included in a system comprising a user terminal device and a server device, the user terminal device comprising:
the optical device,
the data interface, and
a data transfer interface for transmitting data based on the optically received auxiliary information to the server device and for receiving the instruction data from the server device, and
the server device comprising:
the processing system arranged to retrieve the instruction data from the database, and
a data transfer interface for transmitting the instruction data to the user terminal device and for receiving the data based on the optically received auxiliary information from the user terminal device,
wherein the data interface of the user terminal device is arranged to present the instruction data to a user of the user terminal device so as to enable the user to retrieve the information related to the product from the product itself.

64. An arrangement according to claim 50, wherein the arrangement is included in a system comprising a user terminal device comprising:
the optical device,
the data interface, and
the processing system,
wherein the data interface of the user terminal device is arranged to present the instruction data to a user of the user terminal device so as to enable the user to retrieve the information related to the product from the product itself.

65. A user terminal device for enabling a user to retrieve information related to a product, the user terminal device comprising:
an optical device arranged to optically receive auxiliary information from a surface of the product,
a processing system arranged to retrieve instruction data from a database on the basis of the optically received auxiliary information, the instruction data describing actions to be performed by the user in order to retrieve the information related to the product from the product itself, and
a user interface arranged to present the instruction data to the user,
wherein the processing system is arranged to carry out, on the basis of the optically received auxiliary information, at least one of the following (i-iii): (i) individualization of the product, (ii) identification of a production batch to which the product belongs, (iii) identification of an age group of the product, and the processing system is arranged to select the instruction data from among all instruction data stored in the database on the basis of at least one of the following: the individualization of the product, the production batch, the age group, and wherein the instruction data is arranged to indicate, from the surface of the product, areas which are to be exposed to one of the following actions in order to retrieve the information related the product: warming the areas on the surface of the product, pressing the areas on the surface of the product, exposing the areas on the surface of the product to moisture.

66. A user terminal device according to claim 65, wherein the instruction data comprises instructions to the user so as to enable the user to verify whether the product is genuine or counterfeit.

67. A user terminal device according to claim 65, wherein the user terminal device comprises a data transfer interface for receiving the instruction data from a separate device including the database.

68. A user terminal device according to claim 65, wherein the user terminal device comprises a memory device for storing the database.

69. A user terminal device according to claim 65, wherein the user terminal device comprises at least one of the following: a mobile phone, a palmtop computer, a personal digital assistant.

70. A server device comprising a data transfer interface for receiving data from a user terminal device and for transmitting data to the user terminal device, and a processing system arranged to:
retrieve instruction data from a database on the basis of auxiliary information received from the user terminal device, the instruction data describing actions to be performed by a user of the user terminal device in order to retrieve information related to a product from the product itself, and
control the data transfer interface to transmit the instruction data to the user terminal device,
wherein the processing system is arranged to carry out, on the basis of the received auxiliary information, at least one of the following (i-iii): (i) individualization of the product, (ii) identification of a production batch to which the product belongs, (iii) identification of an age group of the product, and the processing system is arranged to select the instruction data from among all instruction data stored in the database on the basis of at least one of the following: the individualization of the product, the production batch, the age group, and wherein the instruction data is arranged to indicate, from the surface of the product, areas which are to be exposed to one of the following actions in order to retrieve the information related the product: warming the areas on the surface of the product, pressing the areas on the surface of the product, exposing the areas on the surface of the product to moisture.

71. A server device according to claim 70, wherein the instruction data comprises instructions to the user of the user terminal device so as to enable the user of the user terminal device to verify whether the product is genuine or counterfeit.

72. A server device according to claim 70, wherein the processing system is arranged to retrieve the instruction data via the data transfer interface from a separate device including the database.

73. A server device according to claim 70, wherein the server device comprises a memory device for storing the database.

74. A method for enabling an acting party to retrieve information related to a product, the method comprising:
receiving optically auxiliary information from a surface of the product,
retrieving instruction data from a database on the basis of the optically received auxiliary information, the instruction data describing actions to be performed in order to retrieve the information related to the product from the product itself,
delivering the instruction data to the acting party so as to enable the acting party to retrieve the information related to the product from the product, and
carrying out, on the basis of the optically received auxiliary information, at least one of the following (i-iii): (i) individualization of the product, (ii) identification of a production batch to which the product belongs, (iii) identification of an age group of the product, and the method further comprises selecting the instruction data from among all instruction data stored in the database on the basis of at least one of the following: the individualization of the product, the production batch, the age group,
wherein the instruction data indicates, from the surface of the product, areas which are to be exposed to one of the following actions in order to retrieve the information related the product: warming the areas on the surface of the product, pressing the areas on the surface of the product, exposing the areas on the surface of the product to moisture.

75. A method according to claim 74, wherein the instruction data comprises instructions to the acting party so as to enable the acting party to verify whether the product is genuine or counterfeit.

76. A method according to claim 74, wherein the method comprises producing a photograph of the product with a camera, applying image recognition to the photograph of the product, and retrieving the instruction data from the database on the basis of the result of the image recognition.

77. A method according to claim 76, wherein at least one of the following image recognition algorithms is used for the image recognition: Color Coherent Vector (CCV), Gradient Location and Orientation Histogram (GLOH), Local Binary Pattern (LBP), Local Energy based Shape Histogram (LESH), Scale-invariant feature transform (SIFT), Speeded Up Robust Features (SURF).

78. A method according to claim 74, wherein the method comprises optically reading a graphical code pattern from the surface of the product and retrieving the instruction data from the database on the basis of the auxiliary information represented by the graphical code pattern.

79. A method according to claim 74, wherein method comprises decoding at least one of the following graphical code patterns: a bar code, a matrix code, a string of alpha-numeric characters, figure elements, visual features.

80. A method according to claim 74, wherein at least a part of the instruction data is presented in a form of an image on a display screen.

81. A method according to claim 74, wherein at least a part of the instruction data is presented in a form of a text on a display screen.

82-86. (canceled)

87. A non-transitory computer readable medium encoded with a computer program for enabling an acting party to retrieve information related to a product, the computer program comprising computer executable instructions for controlling a programmable processor to:
retrieve instruction data from a database on the basis of auxiliary information received optically from a surface of the product, the instruction data describing actions to be performed in order to retrieve the information related to the product from the product itself,
control a data interface to deliver the instruction data to the acting party so as to enable the acting party to retrieve information related to the product from the product, and
carry out, on the basis of the optically received auxiliary information, at least one of the following (i-iii): (i) individualization of the product, (ii) identification of a production batch to which the product belongs, (iii) identification of an age group of the product, and the computer program comprises computer executable instructions for controlling the programmable processor to select the instruction data from among all instruction data stored in the database on the basis of at least one of the following: the individualization of the product, the production batch, the age group.

88. A non-transitory computer readable medium according to claim 87, wherein the instruction data comprises instructions to the acting party so as to enable the acting party to verify whether the product is genuine or counterfeit.

89. A product comprising image elements on the surface of the product, the image elements being responsive to physical actions directed to the image elements and information related to the product being arranged to be indicated so that the image elements are arranged to respond to the physical actions in a pre-determined manner as a response to a situation in which the physical actions are according to pre-determined instructions, wherein the pre-determined instructions are specific to at least one of the following: the product itself as an individual product, a production batch to which the product belongs, an age group of the product, and wherein the image elements are located on the surface of the product on areas indicated by the instruction data and the image elements are to be exposed to one of the following actions in order to retrieve the information related the product: warming the image elements, pressing the image elements, exposing the image elements to moisture.

90. A product according to claim 89, wherein at least one of the image elements is a genuineness certificate, and the genuineness of the product is arranged to be indicated so that the genuineness certificate is arranged to respond to the physical actions in the pre-determined manner as a response to a situation in which the physical actions are according to pre-determined instructions.

91. A product according to claim 89, wherein the product is a package for another product.

92. A method for manufacturing a product according to claim 89, the method comprising:
making, by a first member of a production chain of the product, a first part of the image elements, and
making, by a second member of the production chain of the product, a second part of the image elements.
